(19) United States
(12) Patent Application Publication
(10) Pub. No.: US 2010/0196779 A1
(43) Pub. Date: Aug. 5, 2010

(54) FUEL CELL AND ELECTRODE MATERIAL FOR FUEL CELL

(76) Inventors: Toshiki Koyama, Nagano (JP); Makoto Shimizu, Nagano (JP); Eiko Shimizu, Nagano (JP); Tomoya Iwasaki, Nagano (JP)

Correspondence Address: BIRCH STEWART KOLASCH & BIRCH, PO BOX 747, FALLS CHURCH, VA, 22040-0747, US

(21) Appl. No.: 11/887,338

(22) PCT Filed: Mar. 22, 2006
(86) PCT No.: PCT/JP2006/305680

§ 371 Date: Oct. 19, 2009

(30) Foreign Application Priority Data
Mar. 30, 2005 (JP) 2005-100082

(51) Int. Cl. H01M 8/10; H01M 4/86; H01M 4/583

(52) U.S. Cl. 429/480; 252/182.1; 429/534; 977/700; 977/762

(57) ABSTRACT

The present invention provides a fuel cell which is good in gas permeability of a diffusion layer, exhibits good discharge of water vapor and a carbon dioxide gas, and can improve output properties. The fuel cell includes a cell (20), which comprises an electrolyte membrane (22), a cathode layer (24) provided on one side of the electrolyte membrane and an anode layer (26) provided on the other side thereof and in which a redox reaction takes place between a fed fuel, such as methane, and an oxidizing agent, such as oxygen, through the electrolyte membrane (22) to generate an electromotive force, and is characterized in that a diffusion layer (24b, 26b), which is composed of a carbon fiber fabric having a protrusion part (24c, 26c) protruded outward from a side face to which a fuel or oxidizing agent will be fed, is provided on at least one of the cathode layer (24) and the anode layer (26).

### FIELD OF TECHNOLOGY

The present invention relates to a fuel cell and an electrode material for the fuel cell.

### BACKGROUND TECHNOLOGY

A typical cell 10 of a conventional fuel cell is shown in FIG. 7.

A symbol 12 stands for an electrolyte membrane. The cell 10 has a cathode layer 14, which is provided on one side of the electrolyte membrane 12, and an anode layer (fuel electrode) 16, which is provided on the other side thereof. Electrode plates, not shown, are respectively attached to the cathode layer 14 and the anode layer 16, and lead wires (not shown) are respectively connected to the electrode plates.

Fuel and an oxidizing agent (e.g., oxygen, oxygen-containing gas) are fed to the cell 10, and then a redox reaction takes place through the electrolyte membrane 12, so that an electromotive force can be generated.

Electrode materials 14a and 16a, which support catalytic metals for accelerating an electrode reaction, are respectively provided to the cathode layer 14 and the anode layer 16. Each of electrodes is formed by attaching the electrode plate to the electrode material.

Various types of electrode materials have been used, and catalyst layers 14c and 16c are respectively attached to diffusion layers 14b and 16b, which are composed of carbon cloth (or carbon paper).

The catalyst layers 14c and 16c are produced by the steps of: making carbon powder support a catalytic metal, e.g., platinum, ruthenium; mixing the carbon powder supporting the catalytic metal with a solvent, e.g., aqueous nafion solution, to form into paste; applying the paste to the diffusion layers 14b and 16b; and volatilizing the solvent (see Patent Document 1).

### Patent Document 1: Japanese Patent Gazette No. 6-20710

### DISCLOSURE OF THE INVENTION

In the above described structure wherein the catalyst layers 14c and 16c are formed by applying the carbon powder supporting the catalytic metal to the diffusion layers 14b and 16b composed of carbon cloth (or carbon paper), aeration and ventilation cannot be well performed, especially water vapor formed on the cathode is liquefied in the diffusion layer 14b, and the diffusion layer 14b is easily closed, so that feeding air (oxygen) is obstructed and output power is reduced. By increasing current density, an electrode reaction is accelerated and amount of the water vapor is highly increased, so that the output power is much reduced.

In a fuel cell using methanol as fuel, a carbon dioxide gas formed on the anode side is hard to aerate the diffusion layer 16b including methanol, so that the output power must be reduced.

To improve the aeration, the diffusion layers 14b and 16b may be thinner and small holes may be formed in the diffusion layers 14b and 16b, but their strength must be lowered and contact areas with the catalysts must be reduced so that desired output power cannot be gained.

The present invention was conceived to solve the above described problems, and an object of the present invention is to provide a fuel cell and an electrode material for a fuel cell, in each of which diffusion layers have high gas permeability, water vapor and a carbon dioxide gas can be well discharged and output characteristics can be improved.

The fuel cell of the present invention includes a cell, which comprises an electrolyte membrane, a cathode layer provided on one side of the electrolyte membrane and an anode layer provided on the other side thereof and in which a redox reaction takes place between a fed fuel, such as methane, and an oxidizing agent, such as oxygen, through the electrolyte membrane to generate an electromotive force, and is characterized in that a diffusion layer, which is composed of a carbon fiber fabric and has a protrusion part protruded outward from a fuel or oxidizing agent feed side face, is provided on at least one of the cathode layer and the anode layer.

In the fuel cell, the protrusion part may be formed like a rib.

Preferably, the rib-shaped protrusion part is extended in a direction intersecting with a feeding direction of the fuel or the oxidizing agent.

In the fuel cell, the carbon nanofiber layer may be formed on the electrolyte membrane side of the diffusion layer, and a catalyst layer may be formed between the carbon nanofiber layer and the electrolyte membrane.

Further, the catalyst layer may be formed on an electrolyte membrane side face of the diffusion layer.

Preferably, the diffusion layer is formed by carbonizing a silk fabric.

Further, the diffusion layer may be constituted by a carbon nanofiber layer.

The fuel may be methanol, and the diffusion layer composed of the carbon fiber fabric may be formed on the anode side, to which the methanol is fed.

The electrode material of the present invention comprises a carbon fiber fabric, in which a protrusion part is protruded outward from one of side faces.

Preferably, the protrusion part is formed like a rib.

In the electrode material, a carbon nanofiber layer may be formed on the other side face of the carbon fiber fabric.

In the electrode material, a catalyst layer may be formed on the other side face of the carbon fiber fabric.

In the electrode material, the diffusion layer may be formed by carbonizing a silk fabric.

Further, the carbon fiber fabric may be composed of carbon nanofibers.

### EFFECTS OF THE INVENTION

By employing the present invention, the fuel cell and the electrode material for the fuel cell, in each of which the diffusion layers have high gas permeability, water vapor and a carbon dioxide gas can be well discharged and output characteristics can be improved. Especially, in case of using the silk carbonized body, which is formed by carbonizing the silk fabric, as the diffusion layer composed of the carbon fiber fabric, proper spaces are formed between single yarns or twisted yarns constituted by fibers or between fibers of an unwoven fabric, so that permeability and diffusivity of the fuel or gas can be increased and power generating efficiency can be improved. Contact efficiency between the fuel or gas and the catalyst supported by the silk carbonized body or the catalyst layer formed in the silk carbonized body can be increased, so that the catalyst function can be brought out and the electric power can be stably generated.

### BRIEF DESCRIPTION OF THE DRAWINGS

FIG. 1 is a schematic explanation view showing a structure of a fuel cell;

FIG. 2 is an electron micrograph of a carbon fiber fabric formed by carbonizing a silk knitted fabric;

FIG. 3 is an electron micrograph of a surface of a conventional diffusion layer composed of carbon paper;

FIG. 4 is an FE-SEM photograph of silk fibers carbonized at temperature of 2000° C.;

FIG. 5 is a schematic explanation view of a cell of an embodiment, wherein a carbon fiber fabric, which is formed by carbonizing a silk knitted fabric, is used as a diffusion layer of a cathode;

FIG. 6 is a graph showing cell characteristics of the fuel cell shown in FIG. 5 and a fuel cell of a comparative example; and

FIG. 7 is a schematic explanation view showing a cell structure of the conventional fuel cell.

### PREFERRED EMBODIMENTS OF THE INVENTION

Preferred embodiments of the present invention will now be described in detail with reference to the accompanying drawings.

FIG. 1 is a schematic explanation view of an example of a fuel cell 20 of the present invention.

A symbol 22 stands for an electrolyte membrane. In the cell 20, a cathode layer 24 is formed on one side face of the electrolyte membrane 22, and an anode layer (fuel electrode) 26 is formed on the other side thereof. Separators 28 are provided to respectively face the cathode layer 24 and the anode layer 26, a plurality of parallel grooves are formed in the faces facing the cathode layer 24 and the anode layer 26, and the grooves act as an air feeding path 30 and a fuel feeding path 32.

Projected parts, which are formed on the both sides of each groove, contact the cathode layer 24 and the anode layer 26.

By supplying air to the air feeding path 30 and supplying a fuel, e.g., methanol, to the fuel feeding path 32, a redox reaction takes place between the air and the fuel through the electrolyte membrane 22, so that an electromotive force can be generated.

Note that, a type of the fuel cell is not limited in the present invention.

Catalyst layers 24a and 26a, which support catalytic metals for accelerating an electrode reaction, are respectively provided on the electrolyte membrane 22 sides of the cathode layer 24 and the anode layer 26. Diffusion layers 24b and 26b are respectively provided on the air feed side of the cathode layer 24 and the fuel feed side of the anode layer 26.

The present invention is characterized by the diffusion layers 24b and 26b of the cathode layer 24 and/or the anode layer 26.

A production method of the cathode layer 24 and the anode layer 26 will be explained.

The diffusion layers 24b and 26b are composed of carbon fiber fabrics, which have protrusion parts 24c and 26c protruded outward from the air feed side face and the fuel feed side face. The diffusion layer is provided on at least one of the cathode layer 24 and the anode layer 26. In the example shown in FIG. 1, the both of the cathode layer 24 and the anode layer 26 have the protrusion parts 24c and 26c.

The protrusion parts 24c and 26c may be a plurality of independent bosses, but the rib-shaped protrusion parts 24c and 26c shown in FIG. 1 are preferable. For example, the rib-shaped protrusion parts 24c and 26c may be extended in directions intersecting with an air feeding direction and a fuel feeding direction.

By forming the protrusion parts 24c and 26c in the diffusion layers 24b and 26b, spaces are formed between the protrusion parts 24c and 26c, so that air and a fuel can be well flowed and permeability can be improved. Therefore, water vapor generated in the cathode 24 can be easily discharged outward via the spaces between the protrusion parts 24c and the flow path 30. Closing the diffusion layer 24b caused by water vapor can be highly prevented, and air can well permeate through the diffusion layer 24b, so that an electrode reaction can be accelerated and output power can be increased. By employing the rib-shaped protrusion parts (grooves) 24c extended in the direction intersecting with the flow path 30, they can be communicate to the flow path 30 and air can be supplied to the entire diffusion layer 24b, so that air can well permeate and the electrode reaction can be accelerated.

On the other hand, a carbon dioxide gas, which is generated when methanol is, used as the fuel, can be easily discharged outward via the spaces between the protrusion parts 24c and the flow path 32. Therefore, retaining the carbon dioxide gas can be prevented and the electrode reaction can be accelerated.

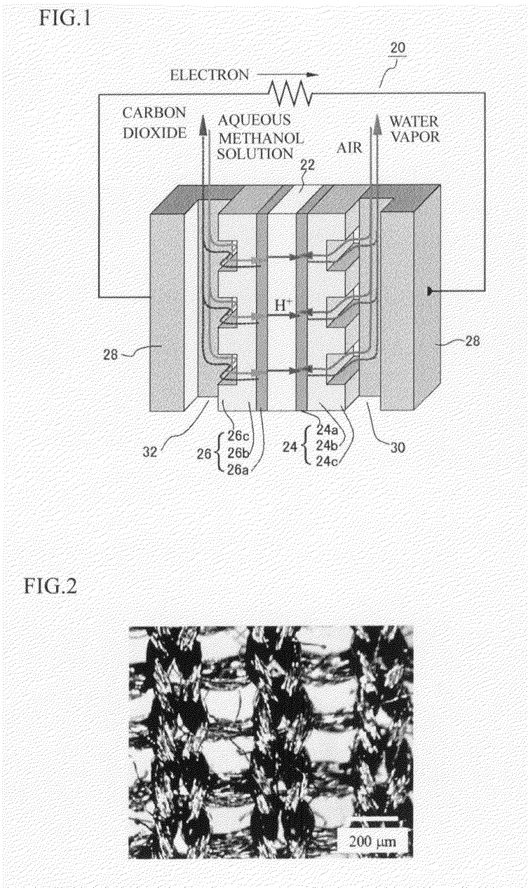

The diffusion layers 24b and 26b having the protrusion parts 24c and 26c, which are composed of carbon fiber fabrics, can be suitably formed by carbonizing, for example, silk knitted fabrics. FIG. 2 is an electron micrograph of the carbon fiber fabric formed by carbonizing the silk knitted fabric. In case of the knitted fabric, rib-shaped protrusion parts (protrusion parts extended in the longitudinal direction in FIG. 2) are formed in one of the surfaces of the knitted fabric, and spaces are formed between the protrusion parts. On the other hand, the other surface of the carbon fiber fabric is a relatively flat surface with no protrusion parts.

By carbonizing the knitted fabric, the rib-shaped protrusion parts can be formed, further independent protrusion parts (not shown) may be formed by carbonizing, for example, a knitted fabric including a plurality of independent bosses.

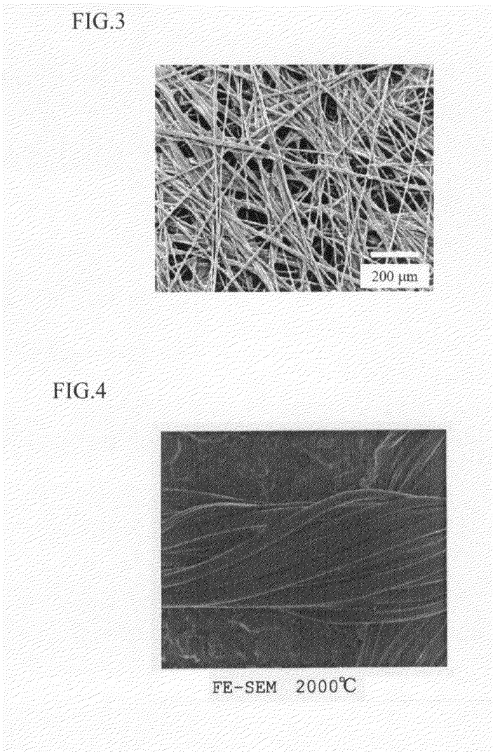

For comparison, FIG. 3 shows an electron micrograph of a surface of a conventional diffusion layer composed of carbon paper. Carbon fibers are randomly piled and extended, and both surfaces are relatively flat surfaces with no protrusion parts.

The silk fabric, e.g., knitted fabric, is carbonized at temperature of 1000-3000° C.

The carbonizing process is performed in an inert gas atmosphere, e.g., nitrogen gas, argon gas, or a vacuum atmosphere so as not to calcine the silk material.

The carbonizing process is performed in stages so as not to rapidly carbonize the material.

For example, the carbonizing process is performed in the inert gas atmosphere, temperature is gradually increased 100° C. or less per hour, preferably 50° C. or less per hour, until reaching primary carbonizing temperature (e.g., 500° C.), and then the material is primarily carbonized at the primary carbonizing temperature for several hours. Next, the temperature is decreased until reaching the room temperature, and then the temperature is gradually increased 100° C. or less per hour, preferably 50° C. or less per hour, until reaching secondary carbonizing temperature (e.g., 700° C.), and the material is secondarily carbonized at the secondary carbonizing temperature for several hours. Next, the material is cooled. Further, the material is thirdly carbonized at final carbonizing temperature (e.g., 2000° C.) so as to form the silk carbonized body. Note that, the carbonizing conditions are not limited to the above example, so they may be optionally changed according to a kind of the silk material, a desired function of the silk carbonized body, etc.

By carbonizing in stages and gradually increasing the temperature, rapid decomposition of protein high-order structures of a dozen amino acids, in which amorphous structures and crystal structures are mixed, can be prevented, and a glossy black and soft (flexible) silk carbonized body can be produced.

The carbonizing process is performed at high temperature of 1000-3000° C. By carbonizing at temperature of 2000° C. of more, the material is graphitized and has high electric conductivity, so it can be used as a suitable electrode material.

A fabric thickness, density, etc. of the silk material can be optionally changed by adjusting thickness of yarns (single yarns), types of twisting yarns, types of knitting or weaving, and density of unwoven fabric, so permeability (fuel permeability and gas permeability) of the silk carbonized body can be optionally controlled.

As shown in an FE-SEM photograph of FIG. 4, there are formed suitable spaces between single yarns, which are constituted by fibers, or twisted yarns constituting the silk carbonized body, so that contact efficiency with the fuel and air can be increased and an electromotive force can be stably generated.

In the above described example, the silk material is formed by carbonizing the silk knitted fabric, but the silk material is not limited to the example. For example, the carbon fiber fabric in which the protrusion parts are formed in one surface may be formed by carbonizing a knitted fabric composed of synthetic resin fibers, e.g., acrylonitrile fibers, phenol resin fibers.

The catalyst layers 24a and 26a are respectively formed on the other surfaces of the diffusion layers 24b and 26b (the surfaces facing the electrolyte membrane 22) or the surfaces opposite to the surfaces in which the protrusion parts 24c and 26c are formed.

For example, carbon fiber fabrics which directly support catalytic metals may be used as the catalyst layers 24a and 26a.

Platinum, platinum alloys, platinum-ruthenium, gold, palladium, etc. may be used as suitable catalytic metals.

A method of supporting the catalytic metal will be explained.

For example, platinum is supported in the silk carbonized body by the steps of: soaking the silk carbonized body in a nitric acid solution or a hydrogen peroxide solution as pretreatment; drying the silk carbonized body; and applying a chloroplatinic acid solution to the silk carbonized body or soaking the silk carbonized body in a chloroplatinic acid solution.

Preferably, the surface of the silk carbonized body may be activated so as to form projections therein and increase surface area thereof before supporting the catalytic metal.

The activation treatment may be performed by, for example, exposing the silk carbonized body to high-temperature water vapor so as to form a large number of fine holes (diameters: 0.1-dozens nm) in the surface thereof.

The silk carbonized bodies supporting the catalytic metal can be used as the electrode materials 24a and 26a.

In case that the carbon fiber fabric is the silk carbonized body formed by carbonizing the silk fabric, as described above, spaces are formed between single yarns or twisted yarns constituted by fibers or between fibers of an unwoven fabric, so that the permeability and the diffusivity of the fuel or gas can be increased and the power generating efficiency can be improved. Further, the contact efficiency between the fuel or gas and the catalyst layer of the silk carbonized body can be increased, so that the catalyst function can be brought out and the electric power can be stably generated.

Each of the catalyst layers 24a and 26a may be formed, as well as the conventional catalyst layers, by the steps of: making the carbon powder support the catalytic metal, e.g., platinum, platinum-ruthenium; mixing the carbon powder supporting the catalytic metal with a nafion solution to form into paste; applying the paste to a surface (one side face) of the carbon fiber fabric; and heating the carbon fiber fabric so as to volatilize the solvent.

Further, the catalyst layer may be formed by the steps of: making the carbon nanofibers, e.g., VGCF (registered trademark), support the catalytic metal, e.g., platinum, platinum-ruthenium; mixing the carbon nanofibers supporting the catalytic metal with a solution, e.g., nafion solution, to form into paste; applying the paste to a surface (one side face) of the carbon fiber fabric; and heating the carbon fiber fabric so as to volatilize the solvent.

The catalytic metal must contact both of the supporting bodies (carbon fibers) and the electrolyte membrane 22. If the catalytic metal thickly contacts the both, the power generation efficiency can be improved.

By employing the high density supporting body, e.g., carbon nanofiber layer, the catalytic metal can be thickly supported.

For example, the carbon nanofiber layer may be formed by the steps of: spinning resin, e.g., acrylonitrile resin, phenol resin, or a silk solution, by electro spinning method, so as to form into nanosize microfine fibers; forming a fabric (woven fabric, knitted fabric or unwoven fabric) with the microfine fibers; and carbonizing the fabric in an inert gas atmosphere.

Since the carbon nanofiber layers are composed of microfine carbon fibers, the catalyst layers 24a and 26a, in which the catalytic metals are thickly supported by the high density supporting bodies, may be formed by making the carbon nanofiber layers directly support the catalytic metals, or by the steps of: making the carbon nanofibers, e.g., VGCF (registered trademark), support the catalytic metal, e.g., platinum, platinum-ruthenium; mixing the carbon nanofibers supporting the catalytic metal with a solution, e.g., nafion solution, to form into paste; and applying the paste to the sheet-shaped carbon nanofiber layers.

By forming the catalyst layers 24a and 26a thickly supporting the catalytic metals, catalytic efficiency can be improved so that output power of the fuel cell can be increased.

Note that, in the above described embodiment, the catalyst layers 24a and 26b are constituted by the carbon nanofiber layers, and the carbon fiber fabrics having the protrusion parts 24c and 26c, which are constituted by the carbon nanofiber layers, may be used as the diffusion layers 24b and 26b. In this case too, the protrusion parts 24c and 26c can be formed by carbonizing the knitted fabric composed of microfine fibers.

### Experimental Example

The fuel cell 20 shown in FIG. 5 was produced.

The diffusion layer 24b of the cathode layer 24 was composed of the silk carbonized body shown in FIG. 2, which was formed by carbonizing the silk knitted fabric. The rib-shaped protrusion parts 24c of the diffusion layer 24b were extended in the direction perpendicular to the flow paths 30. The diffusion layer 24b of the anode layer 26 was composed of ordinary carbon paper.

Constitution of the fuel cell (direct methanol-type fuel cell) and measuring conditions were as follows:
Electrolyte membrane: nafion 117;
Catalyst of anode: PtRu/C (Pt 29.6 wt %, and

### Ru 22.9 wt %);

Amount of loading catalyst: Pt 0.56 mg/cm2,
   Ru 0.44 mg/cm2;
Catalyst of cathode: Pt/C (Pt 46.3 wt %);
Amount of loading catalyst: Pt 1.0 mg/cm2;
Cell temperature: 60° C.; and
Feeding speed: air 0.51 l/min., and
   aqueous methanol solution (1.5M)
      2.8 l/min.

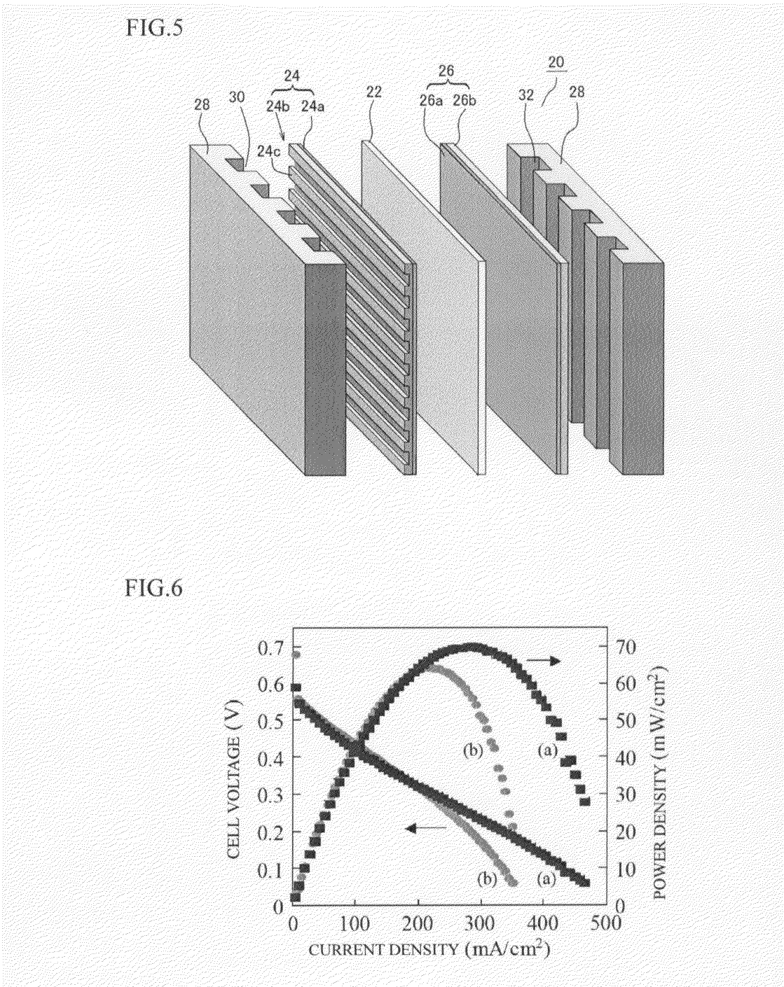

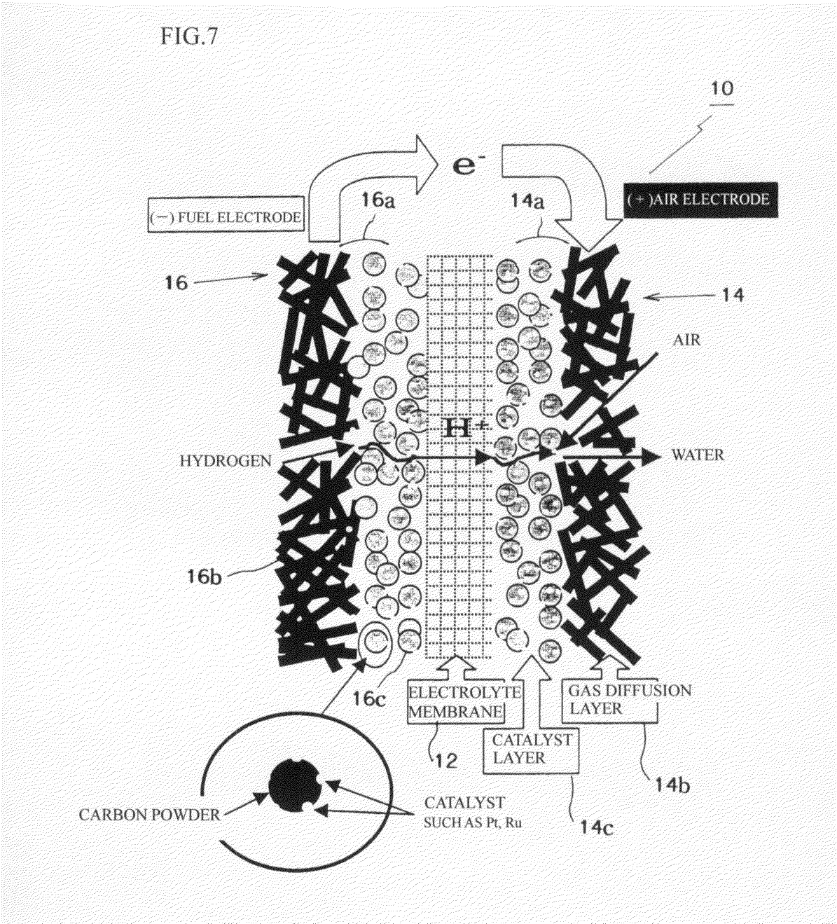

Cell characteristics measured under the above described conditions are indicated as a curve (a) shown in FIG. 6.

Another direct methanol-type fuel cell, in which the diffusion layer 24b of the cathode layer 24 shown in FIG. 5 was also composed of ordinary carbon paper, was produced as a comparative example, and cell characteristics of the comparative example measured under the same conditions are indicated as a curve (b) shown in FIG. 6.

As clearly shown by the curve (a) shown in FIG. 6, cell voltage with respect to current density was linearly varied, voltage drop caused by diffusion eddy voltage was not observed, and close circuit current density and output power density reached 507 mA/cm2 and 70.9 mW/cm2.

On the other hand, in the comparative example, as clearly shown by the curve (b) shown in FIG. 6, voltage drop caused by diffusion eddy voltage was observed from current density of about 200 mA/cm2, and close circuit current density and output power density were limited to 374 mA/cm2 and 63.8 mW/cm2.

1. A fuel cell including a cell, which comprises an electrolyte membrane, a cathode layer provided on one side of the electrolyte membrane and an anode layer provided on the other side thereof and in which a redox reaction takes place between a fed fuel, such as methanol, and an oxidizing agent, such as oxygen, through the electrolyte membrane to generate an electromotive force,
wherein a diffusion layer, which is composed of a carbon fiber fabric and having a rib-shaped protrusion part protruded outward from a side face to which fuel or oxidizing agent will be fed, is provided on at least one of the cathode layer and the anode layer, and
that the rib-shaped protrusion part is extended in a direction intersecting with a feeding direction of the fuel or the oxidizing agent.

2. (canceled)

3. (canceled)

4. The fuel cell according to claim 1, wherein the carbon nanofiber layer is formed on the electrolyte membrane side of the diffusion layer, and a catalyst layer is formed between the carbon nanofiber layer and the electrolyte membrane.

5. The fuel cell according to claim 1,
wherein a catalyst layer is formed on an electrolyte membrane side face of the diffusion layer.

6. The fuel cell according to claim 1,
wherein the diffusion layer is formed by carbonizing a silk fabric.

7. The fuel cell according to claim 1,
wherein the diffusion layer is constituted by a carbon nanofiber layer.

8. (canceled)

9. An electrode material for a fuel cell comprising a carbon fiber fabric, which is formed by carbonizing a silk fabric and in which a rib-shaped protrusion part is protruded outward from one of side faces.

10. (canceled)

11. The electrode material according to claim 9,
wherein a carbon nanofiber layer is formed on the other side face of the carbon fiber fabric.

12. The electrode material according to claim 9, wherein a catalyst layer is formed on the other side face of the carbon fiber fabric.

13. (canceled)

14. An electrode material comprising a carbon fiber fabric, which is composed of carbon nanofibers and in which a rib-shaped protrusion part is protruded outward from one of side faces.

15. The fuel cell according to claim 1,
wherein a carbon nanofiber layer is formed on the electrolyte membrane side of the diffusion layer, and a catalytic metal is supported by the carbon nanofiber layer.

16. The fuel cell according to claim 1,
wherein a catalytic metal is supported by the diffusion layer.

17. The electrode material according to claim 9,
wherein a catalytic metal is supported by the carbon fiber fabric.

18. The fuel cell according to claim 4,
wherein the diffusion layer is formed by carbonizing a silk fabric.

19. The fuel cell according to claim 5,
wherein the diffusion layer is formed by carbonizing a silk fabric.

20. The fuel cell according to claim 6,
wherein a catalytic metal is supported by the diffusion layer.
